(19) United States
(12) Patent Application Publication
(10) Pub. No.: US 2022/0405617 A1
(43) Pub. Date: Dec. 22, 2022

(54) ARTIFICIAL INTELLIGENCE COLLECTORS

(71) Applicant: CLARIFAI, INC., Wilmington, DE (US)

(72) Inventors: Matthew Donald ZEILER, Fort Lee, NJ (US); Alexandros KATECHIS, Lodi, NJ (US); Harmit MINHAS, Queens Village, NY (US); Yang SHENG, Forest Hills, NY (US); Prasanna MESTHA, Byndoor, Karnataka (IN)

(21) Appl. No.: 17/354,115

(22) Filed: Jun. 22, 2021

(51) Int. Cl. G06N 5/04; G06N 20/00

(52) U.S. Cl. CPC G06N 5/04; G06N 20/00

(57) ABSTRACT

Systems, methods and computer program code are provided to process an input data object from a data source, including identifying at least a first collector associated with the data source, adding the input data object to a queue of the at least first collector, and applying a post-queue workflow to the input data object to determine whether to pass the input data object from the queue to an output data sink.

### BACKGROUND

The fields of artificial intelligence and machine learning are increasingly impacting how organizations conduct business and research. While the actual machine learning models are critical to the performance of a machine learning or artificial intelligence project, data to train and maintain the model is just as important. Most models require a large amount of input data for training as well as for use of the model. For example, an image classification model may require thousands of input images to initially train the model, and then thousands more to improve the performance of the model. As another example, once a model is in use, it may require input data to allow the model to perform its intended function. The collection and preparation of datasets is the most time consuming and expensive aspect of most machine learning projects.

It would be desirable to provide systems and methods to substantially reduce the time and complexity of collecting and manipulating input data sets.

### SUMMARY

According to some embodiments, systems, methods and computer program code are provided to provide artificial intelligence collectors. In some embodiments, systems, methods and computer program code are provided to process an input data object from a data source, including identifying at least a first collector associated with the data source, adding the input data object to a queue of the at least first collector, and applying a post-queue workflow to the input data object to determine whether to pass the input data object from the queue to an output data sink.

Pursuant to some embodiments, a pre-queue workflow is provided to determine whether to allow the input data object to be added to the queue. In some embodiments, the pre-queue workflow is a sampling workflow. In some embodiments, the pre-queue workflow is a thresholding workflow. Pursuant to some embodiments, the post-queue workflow operates asynchronously from the pre-queue workflow. In some embodiments, the post-queue workflow is a thresholding workflow.

A technical effect of some embodiments of the invention is an improved and computerized way of obtaining relevant input data for applications such as machine learning models. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system pursuant to some embodiments.

FIG. 2 illustrate a collector pursuant to some embodiments.

FIG. 3 illustrates a process for creating a collector pursuant to some embodiments.

FIG. 4 illustrates a series of collectors pursuant to some embodiments.

FIG. 5 illustrates a portion of a user interface that may be used pursuant to some embodiments.

FIG. 6 is block diagram of a collector platform pursuant to some embodiments.

### DETAILED DESCRIPTION

Typical data streaming applications (such processing data input streams to provide data to machine learning systems) do not have an intelligence layer to make decisions on which data should be allowed through the process or which should be filtered out of the stream. Further, model predictions are commonly performed in a system that is different than the systems used for improving or training those models. To provide models with the additional data that is typically needed for training and improvement, manual processes are performed, or processes involving additional programming and integration with other systems (such as extract, transform and load or “ETL” processes). Embodiments ensure that a stream of data is collected for future use in model building (and with other data sinks) that matches the distribution of data that those models require.

The selection of input data is typically a manual and batch process that is applied to multiple items of input data. Embodiments apply unique considerations to every data point in an input data stream to decide whether each particular input should be passed through a collector for delivery to an application or other data sink. Embodiments perform such collector operations without additional coding or integration.

An enterprise may want to collect or otherwise identify a large amount of data for the purpose of training machine learning or artificial intelligence (“AI”) models (generally referred to herein as “models”). By way of example, an enterprise that is developing a model to identify vehicles in images may need to tag or “annotate” a large number of images to train and improve one or more models to identify those vehicles. This can require a large number of input images. Collecting these images can be expensive and time consuming. Often, enterprises have access to data associated with other projects (e.g., such as other machine learning projects) or data sources. Embodiments allow “collectors” to be created that automatically collect data for use in an application (such as a machine learning application). The data may include images, video, audio, text or any other data type used as input to a model for prediction (or as output from a model as a prediction). A “collector” as used herein may include one or more filters, sampling algorithms, models or other components composing one or more workflow graphs of computation that are configured to determine if an item of data should be output (or “collected”). In this way, a number of different data sources can be used as inputs, and the components of the collector can be configured to only collect data of interest.

For convenience and ease of exposition, a simple illustrative example will be used to describe features of some embodiments. Those skilled in the art, upon reading the present disclosure, will appreciate that the example is not limiting and that embodiments may be used to create collectors for a large variety of different types of data as well as a large number of different types of machine learning applications.

In the illustrative example, an enterprise is developing and operating models to identify types of vehicles, including a model to identify trucks (referred to herein as the “truck identification model”). Training the model requires a large number of input images, including images that include trucks as well as images that do not include trucks. The enterprise has access to outputs from another model (a “general” model) that identifies items in images. The general model, through its normal operation, often identifies images with vehicles in them. Embodiments allow the enterprise to build and deploy a collector that accesses the outputs from the general model to collect outputs in which a vehicle has been identified. Further, the collector may be configured to only collect outputs from the general model where the prediction confidence of the model is above a threshold. In this manner, as the general model performs predictions, the truck identification model collects input data for its own use. Multiple ones of these collectors may be created, allowing the truck identification model to benefit from the outputs of multiple data sources. As will be described further below, collectors may be configured with a number of different data sources, and the description of the use of a prediction output as a data source is for illustrative purposes only. As used herein, the term “automated” or “automatic” may refer to, for example, actions that can be performed with little or no human intervention.

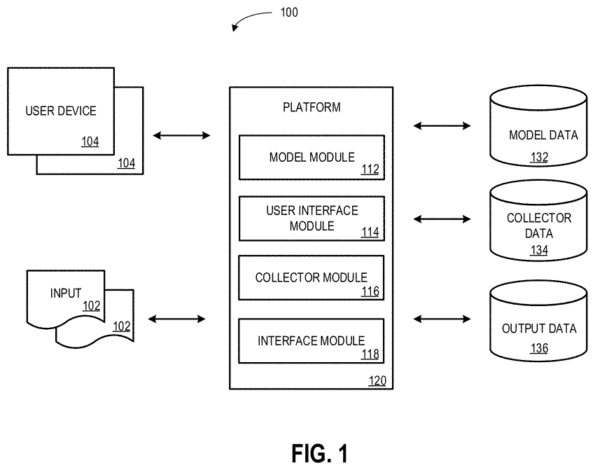

Features of some embodiments will now be described by first referring to FIG. 1 which is a block diagram of a system 100 according to some embodiments of the present invention. As shown, system 100 includes a machine learning platform 120 which receives inputs 102 (such as images, videos or the like) and which produces outputs (stored as output data 136) such as predictions and other information associated with application of models to the inputs 102. The system 100 allows one or more users operating user devices 104 to interact with the machine learning platform 120 to perform processing of those inputs 102 as described further herein. The machine learning platform 120 includes one or more modules that are configured to perform processing to implement and execute one or more “collectors” pursuant to the present invention which allow inputs from one or more sources to be collected for use in one or more models or other output destinations (such as other workflows, applications or the like).

The system 100 may generally be referred to herein as being (or as a part of) a “machine learning system”. The system 100 can include one or more models that may be stored at model database 132 and interacted with via a component or controller such as model module 112. In some embodiments, one or more of the models may be so-called “classification” models that are configured to receive and process inputs 102 and generate output data 136. As used herein, the term “classification model” can include various machine learning models, including but not limited to a “detection model” or a “regression model.” Embodiments may be used with other models, and the use of a classification model as the illustrative example is intended to be illustrative but not limiting. As a result, the term “model” as used herein, is used to refer to any of a number of different types of models (from classification models to segmentation models or the like). As used herein, the term “classification model” can include various machine learning models, including but not limited to a “detection model” or a “regression model.” Embodiments may be used with other models, and the use of a classification model as the illustrative example is intended to be illustrative but not limiting. As a result, the term “model” as used herein, is used to refer to any of a number of different types of models (from classification models to segmentation models or the like).

For convenience and ease of exposition, to illustrate features of some embodiments, the term “confidence score” is used to refer to an indication of a model's confidence of the accuracy of an output (such as a “concept” output from a model such as a classification model). The “confidence score” may be any indicator of a confidence or accuracy of an output from a model, and a “confidence score” is used herein as an example. In some embodiments, the confidence score is used as an input to one or more collectors to determine further processing actions as will be described further herein.

The present application includes a platform 120 that includes one or more collectors that are created to monitor one or more input data sources 102 (which may be, for example, prediction streams or other data sources) to collect input data therefrom for delivery to one or more output data sinks 136. For example, the input data may be obtained from a prediction stream associated with a machine learning model (such as a classification model or the like) and collector rules (including pre- and post-collector workflows as will be described below) may operate on that input data to ensure that only relevant or desired input data is passed from the collector to an output data sink or other destination.

According to some embodiments, the platform 120 may include one or more “automated” collectors that may automatically receive or monitor input data from one or more data sources, perform processing on that data, and output the data to one or more data sinks or output destinations. The processing may allow the selection of specific input data for output to the output locations, allowing complex operations to be performed to ensure appropriate data is output. The result is a system that ensures accurate data is presented at an output without manual intervention or further processing outside the system 100.

In some embodiments, a user device 104 may interact with the platform 120 via a user interface (e.g., via a web browser) where the user interface is generated by the platform 120 and more particularly by the user interface module 114. In some embodiments, the user device 104 may be configured with an application (not shown) which allows a user to interact with the platform 120. In some embodiments, a user device 104 may interact with the platform 120 via an application programming interface (“API”) and more particularly via the interface module 118. For example, the platform 120 (or other systems associated with the platform 120) may provide one or more APIs for the submission of inputs 102 for processing by the platform 120.

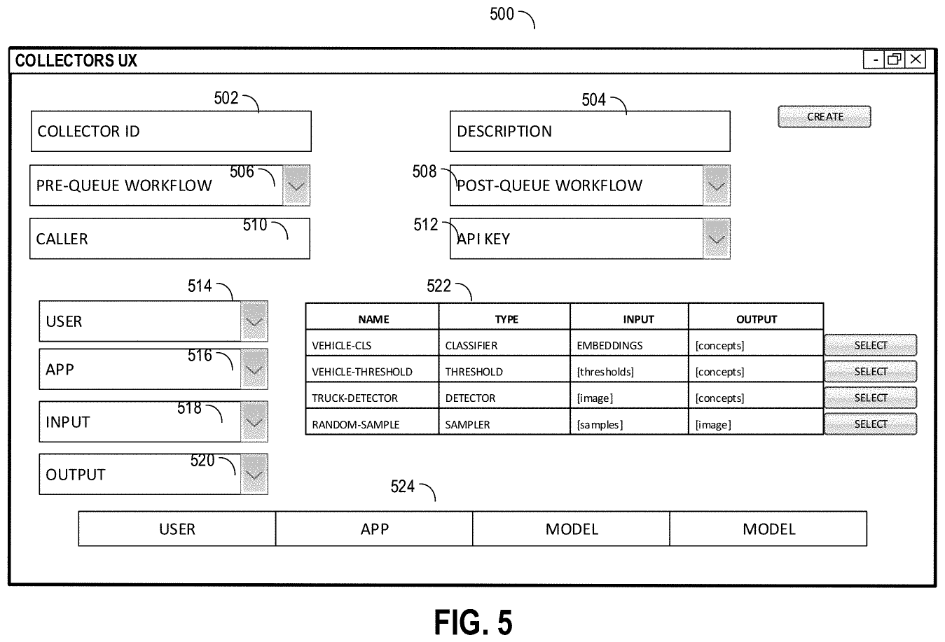

For the purpose of illustrating features of some embodiments, the use of a web browser interface will be described; however, those skilled in the art, upon reading the present disclosure, will appreciate that similar interactions may be achieved using an API. An illustrative (but not limiting) example of a web browser interface pursuant to some embodiments will be described further below in conjunction with FIG. 5.

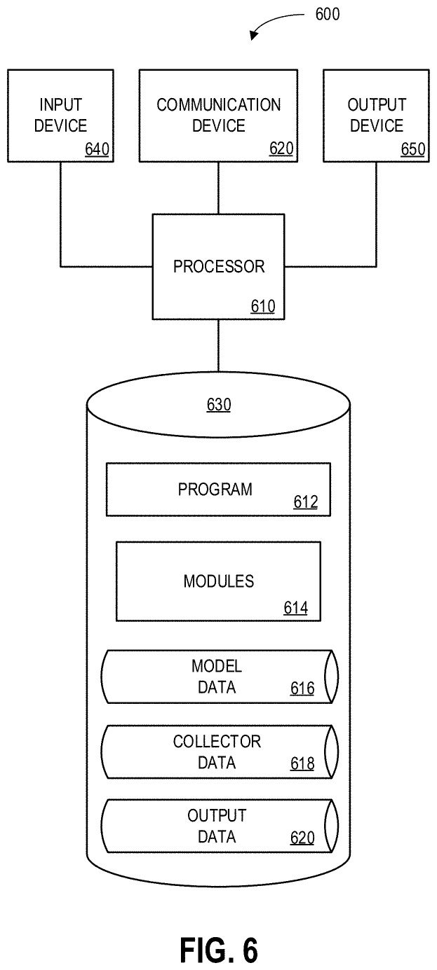

The system 100 can include various types of computing devices. For example, the user device(s) 104 can be mobile devices (such as smart phones), tablet computers, laptop computer, desktop computer, or any other type of computing device that allows a user to interact with the platform 120 as described herein. The platform 120 can include one or more computing devices including those explained below with reference to FIG. 6. In some embodiments, the platform 120 includes a number of server devices and/or applications running on one or more server devices. For example, the platform 120 may include an application server, a communication server, a web-hosting server, or the like.

The devices of system 100 (including, for example, the user devices 104, inputs 102, platform 120 and databases 132, 134 and 136) may communicate using any communication platforms and technologies suitable for transporting data and/or communication signals, including any known communication technologies, devices, media, and protocols supportive of data communications. For example, the devices of system 100 may exchange information via any wired or wireless communication network such as the Internet, an intranet, or an extranet. Note that any devices described herein may communicate via one or more such communication networks.

Although a single platform 120 is shown in FIG. 1, any number of such devices may be included. Moreover, various devices described herein might be combined according to embodiments of the present invention. For example, in some embodiments, the platform 120 and collector database 134 (or other databases) might be co-located and/or may comprise a single apparatus.

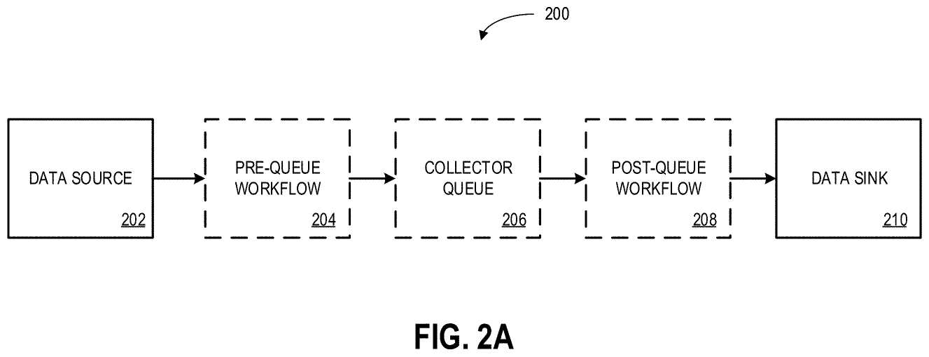

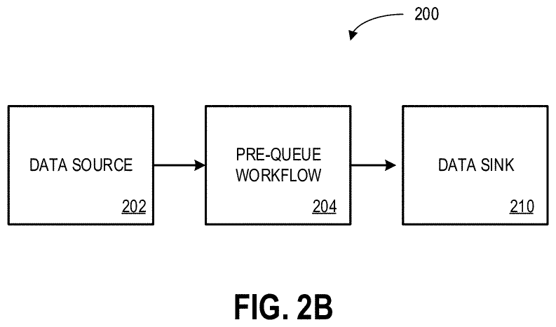

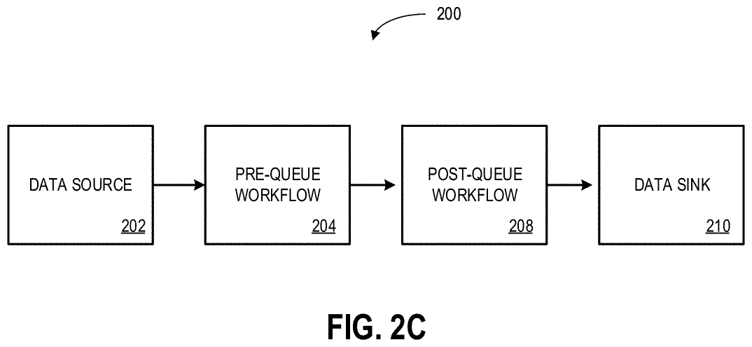

Reference is now made to FIG. 2 where an illustrative collector 200 is shown. The collector 200 may be formed from a collection of processes or programs that act on data from a data source 202 to selectively act on the data such that specific data is passed to an output (e.g., such as a data sink 210). Each collector 200 may be configured with one or more workflows (such as a pre-queue workflow 204 and a post-queue workflow 208) that allow data from the data source 202 to be sampled and filtered to ensure that only desired data is passed to the output. The collector 200 of FIG. 2 may be created via a user interface (e.g., by a user interacting with a user interface of a user device 104 such as the user interface shown below in FIG. 5) or via an API associated with the platform 120. For simplicity and ease of exposition, the collector 200 will be described as being configured via a user interface (although those skilled in the art will appreciate that each step may be performed via an API or the like). Once a collector 200 is created, it may be invoked automatically, each time an input is presented by the data source 202 (e.g., in the illustrative example, the collector 200 may be invoked each time a prediction is made by the general model).

In the illustrative collector 200 shown in FIG. 2A, the collector 200 is configured to obtain data from a data source 202. As discussed above, the data source 202 may be any of a number of types of data sources. For simplicity in describing features of some embodiments, the data source 202 will be described as being a prediction stream of a model (such as the “general” model introduced above in the illustrative example). The general model may constantly produce output data in the form of images, concepts associated with those images inferred by the general model, and the confidence scores associated with each inferred concept. The general model may produce thousands of such output data every few minutes.

As discussed above in the illustrative example, a collector 200 may be created to collect only those input images and data that are relevant to the vehicle model (e.g., to only collect or accept inputs that have vehicles in the image). The collector 200 may, for example, be configured with a pre-queue workflow 204 that samples data in the prediction stream from the general model (the data source 202) and only allows inputs that the general model has inferred as having the concept of a “vehicle” to be added to the collector queue 206. This pre-queue workflow 204 may be implemented using, for example, code configured to monitor the prediction stream from the data source 202 and to add inputs to the collector queue 206 when the input has been identified as having a concept of “vehicle” (or a variant thereof). In some embodiments, the pre-queue workflow 204 may also require that the concept have a certain confidence score associated with it (e.g., only inputs having a concept of vehicle with a confidence score of greater than 50% may be added to the queue). In general, a pre-queue workflow 204 may be configured to determine whether an item of potential input data should be allowed into the collector queue 206. Pursuant to some embodiments, the pre-queue workflow 204 monitors data in the data source 202 to identify inputs that may be allowed into the collector queue 206.

In this way, embodiments create a queue 206 that only includes relevant data from a data source 202. The data in the queue 206 may be further filtered or processed using a post-queue workflow 208. For example, in some embodiments, the pre-queue workflow 204 may serve to sample data from the data source 202, allowing a subset of data from the data source 202 to enter the queue 206. The post-queue workflow 208 may then be configured to only permit high quality data to be passed to an output or data sink 210. In the illustrative example, the queue 206 may be populated with images that have been classified as including a vehicle. The post-queue workflow 208 may be configured to only pass those images which the general model (the input data source 202) classified as including a vehicle with a high confidence score (e.g., only those images having the concept of “vehicle” with a confidence score of greater than 90% may be passed to the output). In this manner, collectors 200 may be configured to apply unique considerations to a large set of potential input data to determine whether each item should be “collected” or provided to the output. In general, the post-queue workflow 208 may perform asynchronous processing on the items that were allowed into the collector queue 206. The asynchronous processing is performed to determine if the data in the collector queue 206 should be written or otherwise outputted to the data sink 210.

In the collector 200 of FIG. 2A, the pre-queue workflow 204, the queue 206 and the post-queue workflow 208 are shown in dotted lines indicating that each of those components may be optionally included or not included in a collector 200. For example, in some embodiments, a pre-queue workflow 204 may not be required. For example, the input data source 202 may not produce a prediction stream or set of data that requires sampling or filtering. As another example, in some embodiments, a post-queue workflow 208 may not be required. For example, the pre-queue workflow 204 may perform sufficient filtering or sampling to ensure that the data output is appropriately tailored to the needs of the data sink 210. For example, referring to FIG. 2B, a collector 200 is shown in which a pre-queue workflow 204 performs processing on an input data stream (from a data source 202) and the data that passes the pre-queue workflow 204 is written or otherwise provided directly to a data sink 210. For example, the collector 200 may monitor a prediction stream and the pre-queue workflow 204 may be configured to randomly sample 10% of the prediction data and pass the sampled data to a data sink 210.

Referring to FIG. 2C, another collector 200 is shown. In the embodiment depicted in FIG. 2C, the collector 200 has both a pre-queue workflow 204 as well as a post-queue workflow 208 (the queue is not shown in FIG. 2C, but some queueing or storage method is likely provided as part of or in front of the post-queue workflow 208). An example of a collector 200 may be one where the pre-queue workflow 204 randomly samples 10% of the data presented at the input from the data source 202 and then the post-queue workflow 208 performs some thresholding to collect those sampled inputs that meet certain threshold requirements. For example, the post-queue workflow 208 may only pass inputs that have been identified by the general model as including the concept of a “vehicle” with greater than a 90% confidence level. In this example, the data sink 210 (such as the vehicle identification model in the example), will only receive high quality inputs (inputs that very likely contain images of vehicles).

In general, the pre-queue workflow 204 is used to pre-process inputs before an input is passed into the queue or before it is passed to an application or other data sink 210 which will use the input. Put another way, a pre-queue workflow 204 may be used to specify one or more sampling rules or filtering rules that can trigger ingestion of an input into a queue. A pre-queue workflow 204 may, for example, be configured to randomly sample inputs (e.g., by allowing one random input out of every five or ten inputs presented in a prediction stream). The pre-queue workflow 204 may also be configured to filter inputs based on metadata associated with an input (e.g., a specific attribute, such as a specific date/time or date range of metadata associated with an input may be required for an input to be passed into the queue 206). The pre-queue workflow 204 may also be configured to filter inputs based on confidence score (e.g., to permit inputs into the queue when the confidence score is above or below or between a specified threshold). In the illustrative example, a pre-queue workflow 204 may be configured to require that inputs from the general model prediction stream have the concept “vehicle” or “truck” with a confidence score of at least 70% for an input to be passed into the queue.

Further, the pre-queue workflow 204 may be configured to perform some knowledge graph mapping from the input data source 202 to a desired output sink 210. For example, a pre-queue workflow 204 may be configured to change the label of a concept from an input source (such as a prediction stream from a general model) to a labeling scheme used in an output data sink 210 (such as a concept labeling convention of the vehicle identification model).

In this way, the use of pre-queue workflows allows the use of an intelligence layer to make decisions on which data should be allowed into a collector process, thereby reducing processing and storage time and costs associated with operating the collector 200.

Collectors pursuant to some embodiments may be used in a number of different applications. For example, collectors aid the process of building machine learning models by enabling the automated collection of training data. This is particularly true when embodiments are used in conjunction with other models that are in production usage and that produce a stream of prediction data. Further, when collectors are used in conjunction with pre-existing models to provide smart filtering of data for specific application, desirable results may be achieved.

Further, as more and more training data is collected, the risk of data drift can be mitigated by adding or adjusting the filtering criteria of a collector 200. For example, in a collector 200 sampling “cat” and “dog” training data, a workflow might be implemented to sample a smaller percentage of “dog” data if this class of data is overrepresented in the data. As the data distribution changes over time, models in the collector selection workflows could be used to detect data drift and dynamically compensate the collector's selection criteria (e.g., by changing the configuration of a pre-queue workflow) to include data to rebalance the training data for future versions of the model to incorporate the underlying changes of the data distribution it is predicting on.

Embodiments may also be used in search indexing applications. For example, searching through a large data collection can be a computationally-expensive task. A collector 200 may be created to analyze a dataset as it is being imported into the platform and to store indexing information about the dataset. This information may then be used to quickly search over a large dataset. Other applications of collectors pursuant to the present invention include use in outlier detection, continuous model improvement, data analytics, data synchronization, data ingestion and ETL processes, active learning or the like.

In some embodiments, a collector platform 120 may allow users to create “applications” or “workflows” which specify how inputs are to be processed. Workflows or applications may invoke other workflows (for example, workflows may be nested or chained). In some embodiments, a workflow may include one or more collectors 200.

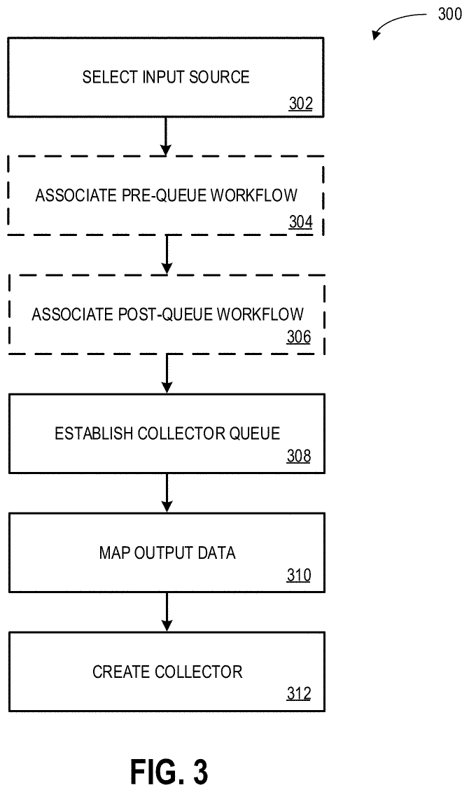

Reference is now made to FIG. 3 where a collector creation process 300 pursuant to some embodiments will be described. Further, the process 300 will be illustrated by reference to the user interface 500 of FIG. 5. The collector creation process 200 as shown is one that might be performed by some or all of the elements of the system 100 described with respect to FIG. 1 according to some embodiments of the present invention. The flow charts and process diagrams described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

Collector creation process 300 may begin at 302 where a user interacts with a platform such as the platform 120 of FIG. 1 to select an input source as the source for the new collector. The input source may be any of a number of different types of data sources. In some embodiments, the input data source may commonly be a prediction stream from a machine learning model. That is, the input data source may be a stream of outputs from a machine learning model. In the illustrative example introduced above, the input data source may be the prediction stream produced by the operation of the general model. As discussed above, the general model may output a number of different types of predictions (including identifying objects vehicles as well as other items). The prediction stream of the general model may be selected at 302 as the input data stream for a collector.

Other types of input data sources may be used. For example, inputs may be obtained from data storage systems (such as hard drives, cloud storage such as Amazon S3, Google Cloud Storage, Dropbox, or the like), data warehouses or data lakes (such as Snowflake, etc.), social media data streams, ETL data streams, APIs or the like. As discussed above, for the purposes of illustration, the data source will be described as being a prediction stream.

Once the input data source has been selected, processing continues at 304 where an optional pre-queue workflow may be associated with the collector. In some embodiments, a collector may have at least one of a pre-queue workflow or a post-queue workflow associated with it. In general, the workflows apply one or more operations to the input data to help ensure that desired data is output from the collector. In general, a pre-queue workflow may be used to selectively permit data from the input data stream to be added to the collector queue. As an example, a pre-queue workflow may be associated with the collector which randomly samples inputs from the input data source. As a particular example, the pre-queue workflow may be a random sample model that allows a random 10% of inputs to be passed into the collector queue. In some embodiments, the pre-queue workflow associated at 304 may be a pre-existing workflow that performs a desired function (e.g., such as performing a random sampling of inputs, or performing a filter function, or some other decisioning), or is adapted or modified to perform a desired function.

In many scenarios, a user will only want to ingest a sample, or subset of a given data source into a model or application. Pre-queue workflows allow users to pre-process inputs so that they are sampled and filtered before it is ever added to an application or model. Pre-queue workflows also allow users to specify sampling rules for triggering data ingestion. Common pre-queue workflows are designed to: (i) randomly sample inputs; (ii) filter inputs by metadata; (iii) filter inputs with a maximum probability below a given threshold; (iv) filter inputs with a minimum probability above a given threshold; (v) filter specific concept probabilities above a given threshold; or (vi) perform knowledge graph mapping from other models (e.g., such as the general model discussed above) and their concepts to a custom model.

Processing continues at 306 where an optional post-queue workflow may be associated with the collector. In general, a post-queue workflow may asynchronously determine which data in the collector queue should be passed as an output from the collector. As an example, a post-queue workflow may be created and associated with the collector that uses one or more threshold models to only allow input data that matches pre-defined thresholds to pass to the output of the collector. In some embodiments, the posts-queue workflow associated at 306 may be a pre-existing workflow that performs a desired function (e.g., such as applying a threshold, performing a filter function, or performing some other decisioning), or is adapted or modified to perform a desired function.

Processing continues at 308 where a collector queue is created. In general, the creation of the collector queue may be automatically performed with the creation of a collector (and is shown as a separate step in FIG. 3 for descriptive purposes only). The collector queue may be a queue implemented in software or as a database to queue the data from the input source or from the pre-queue workflow (if one exists) for operation by the post-queue workflow (if one exists) to determine which inputs to pass as an output of the collector.

Processing continues at 310 where the data to be output from the collector may be mapped (e.g., if the output location or data sink requires a different format or layout of data). Processing at 310 may also include specifying any permissions (e.g., such as user or API permissions) to allow the output data to be passed to a data sink.

Processing continues at 312 where the collector is created. Creation of the collector may, in some embodiments, put the collector into use such that it immediately receives inputs from the input data source and processes those inputs. In some embodiments, the collector may require activation or scheduling to be activated for use. While creation of a single collector was discussed, in practical application multiple collectors may be created and may run at the same time. Further, multiple collectors may produce output that is delivered to the same data sink (e.g., for use by another model or the like). In the illustrative example introduced above, the truck identifier model may receive input data from a number of different collectors, providing the truck identifier with input data for training or the like.

In some embodiments, the collector creation process 300 may be performed by interacting with an API (and one or more of the steps of FIG. 3 may be associated with methods of the API). In some embodiments, the collector creation process 300 may be performed by a user operating with a user device 104 to interact with collector platform 120 via a user interface module 114. An illustrative user interface 500 is shown in FIG. 5. FIG. 5 depicts a user interface 500 that may be presented as a Web browser interface to a user operating a user device 104. A user may interact with different elements (shown as items 502-524) to create a collector pursuant to the present invention. For example, the user interface 500 may include a field 502 in which an identifier of the collector is input by a user (or which is automatically generated or assigned by the system). A description 504 may be provided (e.g., to allow other users to understand the purpose of the collector). A user may select or associate a pre-queue workflow and/or a post-queue workflow by interacting with drop down boxes 506, 508 (which may present the user with a list of existing workflows and/or an option to create a new workflow).

A caller may be specified at 510. The caller may be a user or a group of users that are permitted to invoke the collector. In some embodiments, a user without express permissions will not be able to use or invoke the collector. An API key 512 may also be selected to identify the API key to use to allow new inputs to be posted as outputs from this collector. In some embodiments this key may be an ID or API key associated with the post-queue workflow ID of the workflow to run to after the collector has processed the queued input. In some embodiments, the API key is specified along with the scopes (or permissions) that the collector needs. As a specific example, the API key must have a scope permitting it to post inputs, since it grants the collector the authority to post inputs from the collector to a data sink or application.

Information identifying the application to which the data is to be posted or saved may be identified in field 516 and information identifying the source of the input data is identified at 518. In the dropdown box at 518, a user may, for example, select the model that input data is to be received from. The collector will then automatically receive those inputs and, (based on pre- and post-queue workflow(s)) post the data to an output destination specified in 520. A tabular view of available models and sources may be shown in area 522. In this way, a user can quickly and efficiently create a collector pursuant to the present invention.

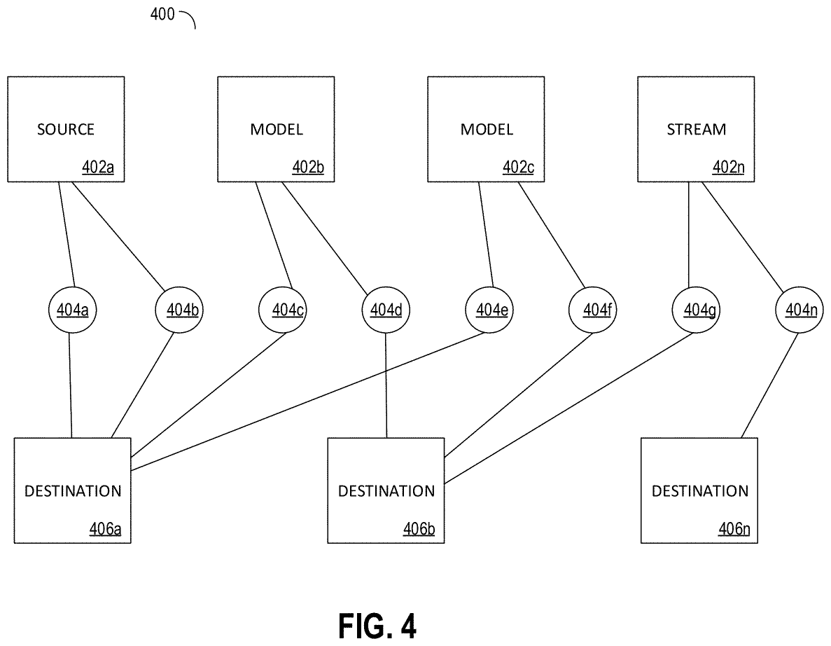

In some embodiments, a collector platform 120 may be implemented in an environment in which multiple data sources are available. For example, reference is now made to FIG. 4 which depicts an environment 400 in which multiple data sources 402a-n are provided and where multiple collectors 404a-n are configured to collect data from those data sources 402 and to provide output data to one or more destinations 406a-n (or data sinks). As an example, the multiple data sources 402a-n may include multiple machine learning models constantly producing prediction streams of output data as well as other data sources (such as FTP locations, object storage locations, databases, input data streams, or the like). Embodiments of the present invention allow those rich sources of data to be filtered and otherwise processed by collectors 404 to reuse relevant items of data for use in other applications or data destinations (such as, for example, as input data for other machine learning models or applications). As shown in FIG. 4, each data source 402 may provide data to more than one collector 404 and for one or more data destination 406. As a specific illustrative example, a general model that produces an active and diverse prediction stream may provide data to a number of collectors 404 (such as a collector to collect “vehicle” data as well as a collector to collect animal or other data for different machine learning models). Embodiments allow machine learning applications to more easily obtain relevant input data for improved model development and training.

The embodiments described herein may be implemented using any number of different hardware configurations. For example, FIG. 6 illustrates a collector platform 600 that may be, for example, associated with the system 100 of FIG. 1 as well as the other systems and components described herein. The collector platform 600 comprises a processor 610, such as one or more commercially available central processing units (CPUs) in the form of microprocessors, coupled to a communication device 620 configured to communicate via a communication network (not shown in FIG. 6). The communication device 620 may be used to communicate, for example, with one or more input sources and/or user devices. The collector platform 600 further includes an input device 640 (e.g., a mouse and/or keyboard to define rules and relationships) and an output device 650 (e.g., a computer monitor to display reports and results to an administrator).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or one or more software modules 614 (e.g., associated with the user interface module, model module, threshold module, and interface module of FIG. 1) for controlling the processor 610. The processor 610 performs instructions of the programs 612, 614, and thereby operates in accordance with any of the embodiments described herein. For example, the processor 610 may receive input data and then perform processing on the input data such as described in conjunction with the processes of FIGS. 2 and 3. The programs 612, 614 may access, update and otherwise interact with data such as model data 616, collector data 618 and output data 620 as described herein.

The programs 612, 614 may be stored in a compressed, uncompiled and/or encrypted format. The programs 612, 614 may furthermore include other program elements, such as an operating system, a database management system, and/or device drivers used by the processor 610 to interface with peripheral devices.

As used herein, information may be “received” by or “transmitted” to, for example: (i) the collector platform 600 from another device; or (ii) a software application or module within the collector platform 600 from another software application, module, or any other source.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A computer implemented method to establish a data collector, the method comprising:
receiving information identifying an input data source producing a first set of input data;
creating a collector queue to queue a second set of input data from the input data source;
receiving information identifying at least one of a pre-queue workflow and a post-queue workflow, the pre-queue workflow operating on the first set of input data to produce the second set of input data, the post-queue workflow operating on the second set of input data to produce a first set of output data; and
outputting the first set of output data for use in an application.

2. The computer implemented method of claim 1, wherein the first set of input data is the same as the second set of input data.

3. The computer implemented method of claim 1, wherein the second set of input data is a random sample of the first set of input data.

4. The computer implemented method of claim 1, wherein the pre-queue workflow applies at least a first threshold to attributes of the first set of input data.

5. The computer implemented method of claim 1, wherein the input data source is a prediction stream of a machine learning model.

6. The computer implemented method of claim 5, wherein each set of input data from the prediction stream includes an input, at least a first predicted concept associated with the input, and at least a first confidence score associated with the at least first predicted concept.

7. The computer implemented method of claim 6, wherein the pre-queue workflow applies a threshold to each set of input data.

8. The computer implemented method of claim 7, wherein the threshold is a threshold associated with the at least first confidence score associated with the at least first predicted concept.

9. The computer implemented method of claim 1, wherein the post-queue workflow asynchronously operates on the second set of input data to produce the first set of output data.

10. The computer implemented method of claim 1, wherein the post-queue workflow is a threshold model.

11. A computing system comprising:
a network interface configured to receive an input data object, the input data object received from a data source; and
a processor configured to
identify at least a first collector associated with the data source;
add the input data object to a queue of the at least first collector; and
apply a post-queue workflow to the input data object to determine whether to pass the input data object from the queue to an output data sink.

12. The computing system of claim 11, wherein the processor is further configured to:
apply a pre-queue workflow to the input data object to determine whether to allow the input data object to be added to the queue.

13. The computing system of claim 12, wherein the pre-queue workflow is configured to select a random sample of data from the data source of the input data to be added to the queue, wherein the input data object is selected to be added to the queue.

14. The computing system of claim 12, wherein the pre-queue workflow is configured to compare at least a first attribute of the input data object to a threshold.

15. The computing system of claim 14, wherein the data source is a prediction stream of a machine learning model.

16. The computing system of claim 15, wherein the input data object includes an input, at least a first predicted concept, and at least a first confidence score associated with the at least first predicted concept.

17. The computing system of claim 16, wherein the at least first attribute is the at least first confidence score.

18. The computing system of claim 12, wherein the post-queue workflow asynchronously operates on the input data object in the queue.

19. The computing system of claim 12, wherein the post-queue workflow is a threshold model and the input data object is passed from the queue to the output data sink if the input data object meets one more thresholds associated with the threshold model.

20. The computing system of claim 12, wherein the output data sink is a machine learning application.
